(19) United States
(12) Patent Application Publication
(10) Pub. No.: US 2021/0410127 A1
(43) Pub. Date: Dec. 30, 2021

(54) USAGE OF ONE OR MORE BANDS WITH DUTY-CYCLE LIMITATION

(71) Applicant: Nokia Technologies Oy, Espoo (FI)

(72) Inventors: Claudio Rosa, Randers NV (DK); Frank Frederiksen, Klarup (DK); Mads Lauridsen, Gistrup (DK); Ignacio Rodriguez Larrad, Aalborg (DK)

(21) Appl. No.: 17/291,076

(22) PCT Filed: Nov. 9, 2018
(86) PCT No.: PCT/EP2018/080769

§ 371 Date: May 4, 2021

(51) Int. Cl. H04W 72/04; H04W 16/14; H04W 36/00

(52) U.S. Cl. CPC H04W 72/044; H04W 36/0072; H04W 16/14

(57) ABSTRACT

It is provided a method, comprising obtaining at least one of a first duty cycle level and a first reception ratio of a terminal using a first band for transmission; deciding whether or not the first band is allowed to be allocated to the terminal based on a predetermined first duty cycle restriction of the first band and the at least one of the first duty cycle level and the first reception ratio; inhibiting allocating the first band to the terminal if the first band is not allowed to be allocated to the terminal.

### FIELD OF THE INVENTION

The present invention relates to UEs using one or more bands with respective duty-cycle limitations such as ISM bands.

### Abbreviations

3GPP 3^{rd} Generation Partnership Project

4G/5G 4^{th}/5^{th} Generation

BS Base Station

DL Downlink

EIRP Equivalent Isotropically Radiated Power

eNB evolved NodeB (base Station in 4G)

e.r.p Effective radiated power

ETSI European Telecommunications Standards Institute

EU European Union

gNB Base Station in 5G/NR

IoT Internet of Things

ISM Industrial, Scientific, and Medical

LBT Listen-Before-talk

LTE Long Term Evolution

NB-IoT Narrowband IoT

NR New Radio (air interface standard of 5G systems)

RA Resource Allocation

RAN Radio Access Network

RFID Radio-Frequency Identification

S1 Interface between base station and core network

TR Technical Report

TS Technical Specification

UE User Equipment

UL Uplink

X2 Interface between two base stations within a network (logical direct interface)

### BACKGROUND OF THE INVENTION

The community is starting to investigate the operation in sub-1-GHz unlicensed frequency bands for multiple systems. One example of such a system is MulteFire, which is having an ongoing work item for creating operation for IoT based services in one or more of the ISM bands that are available for license exempt operation. For the time being, there is no official work item description for MulteFire work, but the NB-loT-U work is part of the second phase of MulteFire 1.1 development.

The only legal condition for operating in such ISM bands is that a set of regulations are followed. At present, the focus is on a few selected frequency bands that have been identified to have less restrictive operation conditions, in terms of transmit power and duty cycle limitations. These are band 47b and band 54 when considering the European regulations. These bands are mentioned in the EU document: (EU) 2017/1483, http://eur-lex.europa.eu/legal-content/EN/TXT/?uri=CELEX:32017D1483. This EU document defines the regulations for harmonisation of the radio spectrum for use by so-called short-range devices.

FIG. 1 shows a table extracted from the EU document 2017/1483. It shows the definition of band 47b as an example of a ISM band, which is under investigation whether or not it may be used by MulteFire.

Band 47b is one of the only frequency bands that allows for relatively high transmit power and a reasonable duty cycle. The duty cycle is defined as the cumulative transmission time within one hour, and in band 47b it can be up to 10% for network access points and up to 2.5% for other devices in the network (mobile units or user equipment). As shown in FIG. 1, the band 47b allows the bandwidth to be used to be up to 200 kHz.

At present, regulation (e.g. ETSI 300-220-1) requires nodes (base station or mobile device) operating in the unlicensed bands (i.e. in bands with duty-cycle restrictions) to have a mechanism to keep track of its own duty cycle and to have internal prevention mechanisms to ensure that the duty cycle limitations are met.

Additionally, the frequency bands indicated to be available for transmission are restricted to 4 specific sub-bands of the band 47b range. These sub-bands coincide with the channels that are defined for the RFID interrogator channels (explained here: https://support.impinj.com/hc/en-us/articles/202756618-UHF-RFID-in-ETSI-Region, and http://www.erodocdb.dk/Docs/doc98/official/pdf/REC7003E.PDF). The RFID interrogator channels are used for providing energy for passive RFID tags to enable communication towards these, and are allowed to transmit with 2 W e.r.p.

In general, there are a number of potential radio bands in the ISM range within Europe. As an example, the table in FIG. 2 indicates the possible bands in the 865 MHz ISM band (taken from Mads Lauridsen, Benny Vejlgaard, Istvan Z. Kovacs, Huan Nguyen, Preben Mogensen: “Interference Measurements in the European 868 MHz ISM Band with Focus on LoRa and SigFox”; IEEE Wireless Communications and Networking Conference, March 2017, San Francisco, USA.)

### SUMMARY OF THE INVENTION

It is an objective of the present invention to improve the prior art.

According to a first aspect of the invention, there is provided an apparatus, comprising means for obtaining configured to obtain at least one of a first duty cycle level and a first reception ratio of a terminal using a first band for transmission; means for deciding configured to decide whether or not the first band is allowed to be allocated to the terminal based on a predetermined first duty cycle restriction of the first band and the at least one of the first duty cycle level and the first reception ratio; means for inhibiting configured to inhibit allocating the first band to the terminal if the first band is not allowed to be allocated to the terminal; wherein the first duty cycle level is a ratio of a time duration used by the terminal for transmitting data on the first band during a predetermined time period preceding a time instance of the obtaining and the predetermined time period; and the first reception ratio is a ratio of a sum of the time durations when the transmission from the terminal in the first band is received during a predetermined time period preceding a time instance of the obtaining and the predetermined time period.

According to a second aspect of the invention, there is provided an apparatus, comprising means for defining configured to define a frequency hopping pattern between a first band and a second band such that a first duty level ratio on the first band does not exceed a first predefined duty cycle restriction and such that a second duty level ratio on the second band does not exceed a second predefined duty cycle restriction; means for setting configured to set one of the first band and the second band as an active band according to the frequency hopping pattern; means for allocating configured to allocate the active band for communicating with a terminal; wherein the second band is different from the first band.

According to a third aspect of the invention, there is provided an apparatus, comprising means for obtaining configured to obtain at least one of a duty cycle level and a reception ratio; means for reporting configured to report on the at least one of the duty cycle level and the reception ratio; wherein the duty cycle level is a ratio of a time duration used for transmitting data to a receiver on a first band during a predetermined time period preceding a time instance of the obtaining and the predetermined time period; and the reception ratio is a ratio of a sum of the time durations when the transmission in the first band is received by the receiver during a predetermined time period preceding a time instance of the obtaining and the predetermined time period.

According to a fourth aspect of the invention, there is provided a method, comprising obtaining at least one of a first duty cycle level and a first reception ratio of a terminal using a first band for transmission; deciding decide whether or not the first band is allowed to be allocated to the terminal based on a predetermined first duty cycle restriction of the first band and the at least one of the first duty cycle level and the first reception ratio; inhibiting allocating the first band to the terminal if the first band is not allowed to be allocated to the terminal; wherein the first duty cycle level is a ratio of a time duration used by the terminal for transmitting data on the first band during a predetermined time period preceding a time instance of the obtaining and the predetermined time period; and the first reception ratio is a ratio of a sum of the time durations when the transmission from the terminal in the first band is received during a predetermined time period preceding a time instance of the obtaining and the predetermined time period.

According to a fifth aspect of the invention, there is provided a method, comprising defining a frequency hopping pattern between a first band and a second band such that a first duty level ratio on the first band does not exceed a first predefined duty cycle restriction and such that a second duty level ratio on the second band does not exceed a second predefined duty cycle restriction; setting one of the first band and the second band as an active band according to the frequency hopping pattern; allocating the active band for communicating with a terminal; wherein the second band is different from the first band.

According to a sixth aspect of the invention, there is provided a method, comprising obtaining at least one of a duty cycle level and a reception ratio; reporting on the at least one of the duty cycle level and the reception ratio; wherein the duty cycle level is a ratio of a time duration used for transmitting data to a receiver on a first band during a predetermined time period preceding a time instance of the obtaining and the predetermined time period; and the reception ratio is a ratio of a sum of the time durations when the transmission in the first band is received by the receiver during a predetermined time period preceding a time instance of the obtaining and the predetermined time period.

Each of the methods of the fourth to sixth aspects may be a method of utilizing a band with duty cycle restriction.

According to a seventh aspect of the invention, there is provided a computer program product comprising a set of instructions which, when executed on an apparatus, is configured to cause the apparatus to carry out the method according to any of the fourth to sixth aspects. The computer program product may be embodied as a computer-readable medium or directly loadable into a computer.

According to some example embodiments of the invention, at least one of the following advantages may be achieved:
UEs may be allowed to use bands with duty-cycle limitation;
Usage of such bands is under control of one of 3GPP or Multefire network;
Reduced access time and reduced data transfer time;
UEs without capability to switch between different bands are supported;
Continuous connectivity of the UE is possible;
Signalling effort may be reduced;
Limited impact on 3GPP specifications.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred example embodiments of the present invention which is to be taken in conjunction with the appended drawings, wherein:

FIG. 1 shows a definition of band 47b according to EU 2017/1483;

FIG. 2 shows subbands and their applications in the European ISM 868 MHz band;

FIG. 3 shows a frequency hopping pattern according to some example embodiments of the invention;

FIG. 4 shows a frequency hopping pattern according to some example embodiments of the invention;

FIG. 5 shows a duty cycle status report according to some example embodiments of the invention;

FIG. 6 shows an apparatus according to an example embodiment of the invention;

FIG. 7 shows a method according to an example embodiment of the invention;

FIG. 8 shows an apparatus according to an example embodiment of the invention;

FIG. 9 shows a method according to an example embodiment of the invention;

FIG. 10 shows an apparatus according to an example embodiment of the invention;

FIG. 11 shows a method according to an example embodiment of the invention; and

FIG. 12 shows an apparatus according to an example embodiment of the invention.

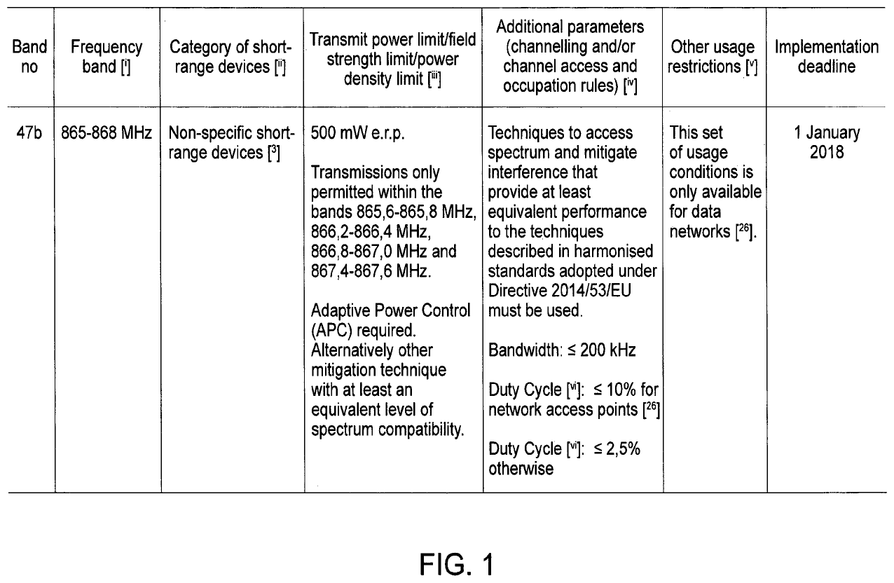

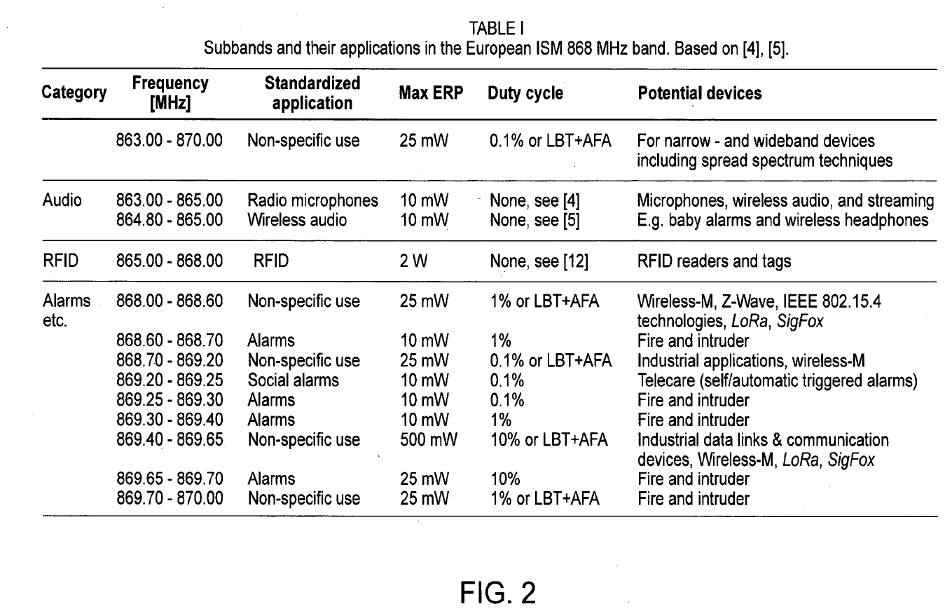

### DETAILED DESCRIPTION OF CERTAIN EXAMPLE EMBODIMENTS

Herein below, certain example embodiments of the present invention are described in detail with reference to the accompanying drawings, wherein the features of the example embodiments can be freely combined with each other unless otherwise described. However, it is to be expressly understood that the description of certain example embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

One of the strengths of the duty-cycle based approach is that it guarantees a limited load from each device in the network. At the same time, this is also a main drawback of the system, as there will be inherent limitations to the time-wise availability of the channels. Hence, some applications might have challenges because the physical layer provides relatively low access and service times when operating in such bands.

Some example embodiments of the invention provide methods to create aggregation and/or switching between operation in multiple duty cycle bands such that the time-wise availability of the resources will be increased. Thus, it allows to reduce the access time, because the waiting time until resources are available is reduced, and reduce the data transfer time, because more resources are available.

In some example embodiments, the aggregation or switching is between band 54 and band 47b, such that each band is operated according to its maximum limitation in terms of duty cycle. In some example embodiments of the invention, a network node may increase the time-wise availability x-fold where x is the number of used system bands.

To utilize this concept, regulations have to allow for independent operation in each of the bands such that the duty cycle is evaluated “per-band”. This is the case for the European regulations for band 47b and band 54.

In some example embodiments of the invention, a device is configured to operate on at least two bands. The radio resources are allocated/configured for transmission of data on each of the configured bands (e.g. by frequency hopping patterns, UL configured grants, etc.). In some embodiments of the invention, the transmitter transmits on one band only at a time.

In some example embodiments of the invention, switching may be based on configured frequency hopping patterns (e.g. periodic switching—not requesting explicit signaling from the transmitter to the receiver). Such switching may be less dynamic. There are several options.

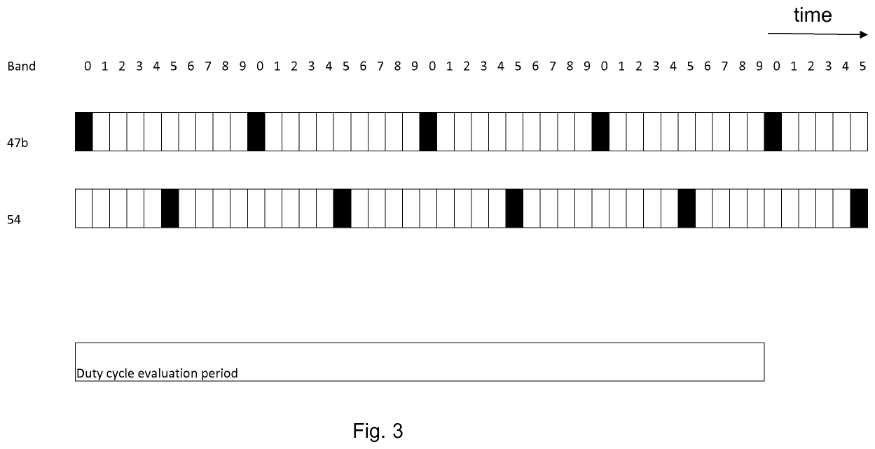

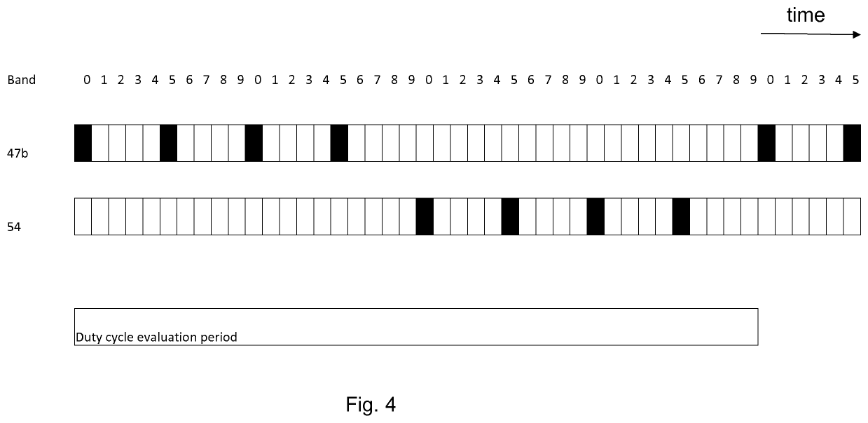

For example, sequential hopping or block-wise hopping (or a combination of both) may be used. Some example embodiments of the invention according to these approaches are shown in FIG. 3 and FIG. 4, respectively. According to the example embodiment of FIG. 3, the transmitter (UE or BS) transmits alternately on the first band (e.g. band 47b) and the second band (e.g. band 54), as shown by the dark boxes. According to the example embodiment of FIG. 4, the transmitter (UE or BS) transmits a predefined number of times (4 times in FIG. 4) on the first band, switches then to the second band to transmit another predefined number of times (4 times in FIG. 4) on the second band. The numbers of times on the first band and the second band may be the same (as in the example of FIG. 4) or different from each other.

A main difference between these two implementations is that in the first approach (e.g. FIG. 3), UEs with less capabilities of switching between operation in multiple bands may still operate in a single band while being served with a constant average delay. In the second approach (e.g. FIG. 4), the numbers of transmission times on each carrier might be set such that the transmitter exhausts the duty cycle available on one carrier before it switches to another carrier. This reduces the number of band changes over time, but less capable UEs would suffer from longer gaps of missing service.

In some example embodiments of the invention, the transmitter may use a multitude of bands. In some embodiments of the invention, thus, the transmitter uses a system of aggregated carriers (potentially with different transmission bandwidths, duty cycles and transmit power levels) such that the transmitter is capable of operating always-on.

In these example embodiments, deterministic switching between two or more bands is employed. The deterministic switching may be based on configuration. For example, BS may provide such configuration to UE, e.g. when UE accesses the BS. In some example embodiments, the configuration may be predefined.

In some example embodiments of the invention, the resource allocation of a transmitter (UE or BS (e.g. gNB or eNB)) is switched dynamically from a first band to a second band. For example, the transmitter may switch from one band to another band if the allowed duty cycle (in view of the duty cycle restrictions) is exhausted or nearly exhausted (i.e. equal to the allowed duty cycle minus a predefined margin). If the BS initiates the switching from the first band to the second band, BS may indicate the switching to UE using an intra-cell handover type of procedure (with no/minor impact on 3GPP/MulteFire standard specifications). If the switching is initiated by the UE, such indication may happen via a kind of UE-initiated intra-cell handover procedure (e.g. by a (contention-free or contention based) random-access procedure performed on configured random-access resources in the second band). This would potentially require some changes in 3GPP/MulteFire standard specifications.

In some of these example embodiments, the transmitter indicates to the receiver that it switches from transmission on a first configured band (carrier) to transmission on a second configured band. If the transmitter is a base station (gNB or eNB), BS may inform the receiver (UE) on the switch using an intra-cell handover procedure.

If the transmitter is a UE, the receiver (that is, the base station (gNB or eNB)) may be informed that the UE wants to switch to a second configured band by the UE initiating a random-access procedure on contention-free (or contention-based) random-access resources on the second configured band. The random-access resources may be pre-configured by the base station.

In some example embodiments, when dynamically switching from a first to a second band, the transmitter may also indicate to the receiver for how much time it is prevented from transmitting on the first band. The transmitter and the receiver may then synchronously switch back to the first band after such time has expired, without requiring additional signalling.

A main advantage of an implementation using dynamic switching between bands (as compared to deterministic switching based on the frequency hopping patterns) is that the former does not require the device to support carrier aggregation between the bands. The cost of this advantage is additional signalling overhead associated with switching between bands.

Further, assuming that both base station and UE are capable of switching between sufficient bands, some example embodiments may have continuous (or nearly continuous) connectivity.

If one or more ISM bands (in general: bands with a restriction of duty cycle) are used in a scheduled network (such as a 3GPP network) with one or more base stations, one of the main challenges is to keep track of the activity of each node. While the base station (eNB or gNB, i.e., the scheduling node) always knows its activity time (transmission time) within the past duty cycle evaluation period (e.g. the last hour), knowledge of the remote node's (e.g. UE's) activity (transmission time) is only known to the base station with limited accuracy—and only under the condition that the remote node is always connected to the serving base station during the duty cycle evaluation period. For example, the base station may underestimate the remote node's current duty cycle status if it fails to receive a transmission from the node, or if the node changed its serving base station during the duty cycle evaluation period (effectively making the current base station unaware of past transmissions).

For a scheduled system it is important for the scheduling node to have information on the resource availability in order to serve the connected nodes correctly. Namely, if the transmission of a remote node exceeds the duty cycle restriction of a resource (band), the resource is not available for transmission for some time, regardless of whether the scheduling node schedules the resource for the remote node.

Some example embodiments of the invention provide monitoring and reporting for operation in (unlicensed) bands comprising duty cycle restrictions, e.g. to enable the coexistence of plural transmitting nodes. In some example embodiments of the invention, network nodes (base stations) exchange information on used duty cycle in connection with handovers.

In some example embodiments of the invention, the base stations tries to keep track of the remote node's activity level (duty cycle).

For example, the eNB may create a buffer for monitoring the actual transmission activity of the remote node. In one embodiment, the eNB may create a buffer with e.g. 60 entries—one for each minute (the duty cycle evaluation method is assumed to be 1 hour), and use this for evaluating the used duty cycle over the past hour. In each entry, the eNB will input a number between 0 and 1, corresponding to the duty cycle/activity factor (i.e. the ratio of transmission time of the UE on the band and the duration (1 minute) of the corresponding time period). The entries of the buffer are filled in a rolling manner. The total sum of the entries divided by the number of entries corresponds to the duty time level (transmission ratio) during the latest duty cycle evaluation period.

Of course, the number of entries and the duration of the duty cycle evaluation period are not limited to the above numbers and may be set according to the duty cycle restrictions and the needs of the system.

The transmission ratio is only indicative in nature. It provides a rough picture of the used duty cycle to the base station. The base station may take the transmission ratio into account when scheduling (for instance to reduce service level for selected logical channels from the UE when controlling the quality of service).

In view of the regulations in unlicensed spectrum, the transmitter (UE or gNB) always has to monitor its own activity level on the band with duty cycle restriction. In some example embodiments, the UE reports its activity level to a further node such as a base station. The further node may operate in push mode or pull mode. I.e., the further node may request the UE to deliver a status report of the duty cycle level, or the UE may create a report if/when the device is close to reaching any limitation set up related to duty cycle limitations and report it to the further node. Periodical reporting may also be supported in some example embodiments.

In some example embodiments of the invention, it is provided UE based monitoring and status reporting, where the UE is able to report its resource usage (duty cycle level) towards the gNB/eNB such that it allows the gNB/eNB to perform planning of scheduling actions (to obey duty cycle limitations according to regulations).

According to some example embodiments of the invention, the UE reporting may be implemented in one of the following example ways.

A UE monitors its “duty cycle level” and reports to the eNB/gNB whenever it reaches a certain threshold (preconfigured or configured by eNB/gNB). Such threshold could be “X % of duty cycle reached”. In one example implementation, the value of X is configured by the network while the UE reports the fraction of the evaluation period (e.g. 1 hour) that it took the UE to reach the activity/duty cycle of X %. In an alternative implementation, the UE signals the fraction of the evaluation period which is left.

In yet another implementation, the UE signals the exact “buffer” information as described above for the transmission ratio. This reporting may be implemented in a similar way as current measurement objects and/or buffer status reports are configured in LTE and/or NR.

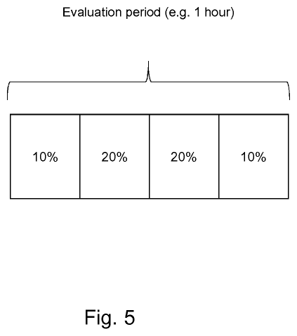

In this implementation, the time and duty cycle granularity for the reports may be fixed (e.g. by a 3GPP specification) or configurable by the network. E.g. assuming an evaluation period of 1 hour, the time granularity T could be set to 15 minutes, while the duty cycle granularity could be set to 10%. Upon detecting that the duty cycle has reached X %, the UE sends a report consisting of 4 (=60/15) fields each one indicating a value between 0% and 100% (with 10% granularity). An example is shown in FIG. 5.

In the example of FIG. 5, UE reports to the remote node that it transmitted 10% of 15 min (=1.5 min) during the first and fourth interval of 15 minutes of the last hour on the band with duty cycle limitation, and that it transmitted 20% of 15 min (=3 min) during the second and third interval of 15 min of the last hour on the band with the duty cycle limitation. Thus, gNB knows that UE transmitted a total of 9 min (15%) in the last hour on the band. It may compare this number with the duty cycle restriction to decide whether or not the band with duty cycle will be scheduled for the UE.

In some example embodiments of the invention, the UE may issue a “warning” message using a specific signaling towards the gNB/eNB to indicate that it is reaching its UL duty cycle limit. Such warning message may be issued from the UE in case it observes that it has used for instance 95% of its duty cycle. Having this information, the gNB may prioritize the scheduling for this UE to only take into account high priority traffic, or even consider to do a handover to another band (and set the duty cycle settings for this UE according to the previous usage of the other band). As an example, the signaling from the UE may be implemented as a random access preamble transmission on a dedicated resource.

In some example embodiments of the invention, the BS may request the UE to deliver a report on its “current duty cycle status”. The report may contain parameters which will be relevant for the eNB/gNB in terms of planning the future scheduling actions towards this UE. Some example paramters are as follows:
a. “Currently used” or “remaining” duty cycle at the time of reporting. It may be expressed as a percentage or fraction of the full duty cycle that is allowed. The report may also include “timing” information (fraction of the evaluation period that it took the UE to reach the reported activity/duty cycle, detailed duty cycle status report as illustrated in the example of FIG. 5, etc.)
b. “Projected used” or “remaining duty cycle” Y seconds or minutes after the reporting (this information may be redundant if the duty cycle status report exemplified in FIG. 5 is used for the reporting). The purpose of this report is to provide an indication of the capacity for communication that will be freed due to old traffic not being in scope of the running average window of the duty cycle evaluation period (e.g. one hour). Some examples of this:
   i. The UE calculates the current duty cycle status as a moving average over 1 hour (according to ETSI specification). The report can thus inform the eNB/gNB about the activity in the “oldest 5-10 minutes” in the current window. This allows the eNB/gNB to evaluate how much activity can be scheduled in the future 5-10 minutes. Further, the report could be an aggregate of the indication of current “remaining available duty cycle” and “duty cycle that is released shortly”.
   ii. Based on a periodic/constant traffic the UE can project its duty cycle usage for a short future time window, and inform the eNB/gNB about potential limitations (i.e. postponed transmissions). This approach has an inherent assumption of periodic or constant traffic/communication from the UE to the base station and allows the base station to do “planning” according to additional traffic on top of “normal traffic”.

The UE may periodically or event-based report on the duty cycle level using one of the above-mentioned reporting mechanisms.

In one possible implementation, the duty cycle status report may be used to trigger a handover to a different band and/or system.

Some example embodiments of the invention provide inter-eNB communication to provide information on the activity level (duty cycle) of a previously connected UE. Such communication may be triggered by an inter-eNB handover of the UE. In other words, information on the current duty cycle status of the UE may be exchanged between source and target base stations during the handover procedure, e.g. as part of the UE's context information. Thus, eNB/gNB may keep track of UEs transmission activity in order to avoid that the UE runs out of “airtime” (i.e. must not transmit of the band with duty cycle restriction) through scheduling operation.

There are several options to implement example embodiments of the invention.

If the UE is handed over from one node (source BS) to another node (target BS), information on the transmission ratio and/or duty cycle level is also transferred to the target BS such that the target BS also has (indicative) information on the UEs utilization of the duty cycle.

In some example embodiments of the invention, the status of the UE's duty cycle level or transmission ratio may be part of the X2 or S1 message that is exchanged between the two nodes (BSs) in preparation of or during the actual handover operation. For example, source BS may transfer the status of the buffer to the target BS.

In some example embodiments, UE may report its duty cycle status to the target base station after it is handed over to the target base station.

It should be noted that such eNB based track-keeping of UE utilization of duty cycle is only indicative, as it will be each remote node's responsibility to respect the duty cycle limitations enforced by regulations.

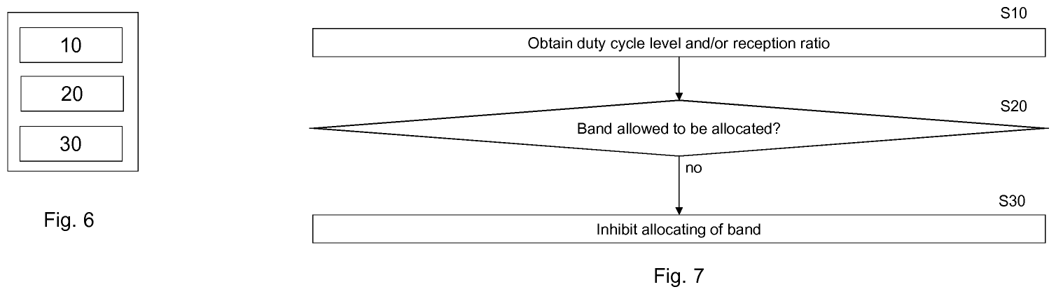

FIG. 6 shows an apparatus according to an example embodiment of the invention. The apparatus may be a base station or an element thereof. FIG. 7 shows a method according to an example embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises means for obtaining 10, means for deciding 20, and means for inhibiting 30. The means for obtaining 10, means for deciding 20 and means for inhibiting 30 may be a obtaining means, deciding means, and inhibiting means, respectively. The means for obtaining 10, means for deciding 20 and means for inhibiting 30 may be an obtainer, decider and inhibitor, respectively. The means for obtaining 10, means for deciding 20 and means for inhibiting 30 may be a obtaining processor, deciding processor, and inhibiting processor, respectively.

The means for obtaining 10 obtains at least one of a duty cycle level and a reception ratio of a terminal (S10). The terminal uses a band for transmission. The duty cycle level is a ratio of a time duration used by the terminal for transmitting data on the band during a predetermined time period preceding a time instance of the obtaining and the predetermined time period; and the reception ratio is a ratio of a sum of the time durations when the transmission from the terminal in the band is received during a predetermined time period preceding a time instance of the obtaining and the predetermined time period.

The means for deciding 20 decides whether or not the band is allowed to be allocated to the terminal (S20). It decides based on a predetermined duty cycle restriction of the band and the at least one of the duty cycle level and the reception ratio. In particular, it may decide that the band is not allowed to be allocated if one or both of the duty cycle level and the reception ratio exceed a predetermined portion of the predetermined duty cycle restriction.

If the band is not allowed to be allocated to the terminal (S20=“no”), the means for inhibiting 30 inhibits allocating the band to the terminal (S30).

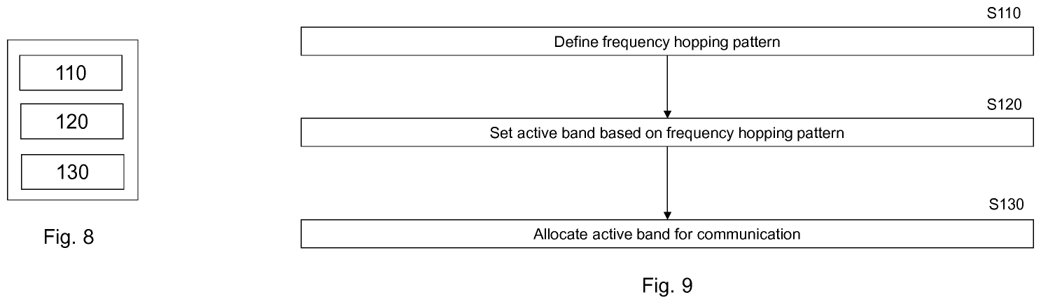

FIG. 8 shows an apparatus according to an example embodiment of the invention. The apparatus may be a base station or an element thereof. FIG. 9 shows a method according to an example embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises means for defining 110, means for setting 120, and means for allocating 130. The means for defining 110, means for setting 120 and means for allocating 130 may be a defining means, setting means, and allocating means, respectively. The means for defining 110, means for setting 120 and means for allocating 130 may be a definer, setter, and allocator, respectively. The means for defining 110, means for setting 120 and means for allocating 130 may be a defining processor, setting processor, and allocating processor, respectively.

The means for defining 110 define a frequency hopping pattern between a first band and a second band (S110). It defines the frequency hopping pattern such that a first duty level ratio on the first band does not exceed a first predefined duty cycle restriction and such that a second duty level ratio on the second band does not exceed a second predefined duty cycle restriction. The second band is different from the first band.

The means for setting 120 sets one of the first band and the second band as an active band according to the frequency hopping pattern (S120).

The means for allocating 130 allocates the active band for communicating with a terminal (S130).

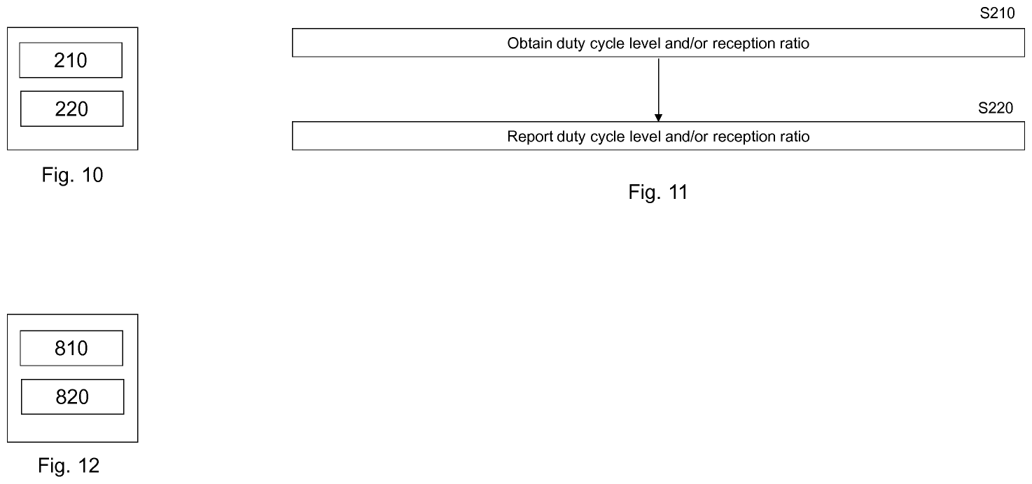

FIG. 10 shows an apparatus according to an example embodiment of the invention. The apparatus may be a base station or an element thereof. FIG. 11 shows a method according to an example embodiment of the invention. The apparatus according to FIG. 10 may perform the method of FIG. 11 but is not limited to this method. The method of FIG. 11 may be performed by the apparatus of FIG. 10 but is not limited to being performed by this apparatus.

The apparatus comprises means for obtaining 210 and means for reporting 220. The means for obtaining 210 and means for reporting 220 may be an obtaining means and reporting means, respectively. The means for obtaining 210 and means for reporting 220 may be an obtainer and reporter, respectively. The means for obtaining 210 and means for reporting 220 may be an obtaining processor and reporting processor, respectively.

The means for obtaining 210 obtains at least one of a duty cycle level and a reception ratio (S210). The duty cycle level is a ratio of a time duration used for transmitting data to a receiver on a band during a predetermined time period preceding a time instance of the obtaining and the predetermined time period. The reception ratio is a ratio of a sum of the time durations when the transmission in the band is received by the receiver during a predetermined time period preceding a time instance of the obtaining and the predetermined time period.

The means for reporting 220 reports on the at least one of the duty cycle level and the reception ratio (S220).

FIG. 12 shows an apparatus according to an example embodiment of the invention. The apparatus comprises at least one processor 810, at least one memory 820 including computer program code, and the at least one processor 810, with the at least one memory 820 and the computer program code, being arranged to cause the apparatus to at least perform at least one of the methods according to FIGS. 7, 9, and 11 and related description.

The second band may or may not have a duty cycle restriction. If the second band has a duty cycle restriction, the means for monitoring may additionally monitor if the duty cycle level on the second band exceeds a respective predetermined portion of the duty cycle restriction of the second band. If the duty cycle level of the second band exceeds the respective portion, the means for setting may be inhibited to set the second band as the active band.

Some example embodiments of the invention are described which are based on a 3GPP network (e.g. NR). However, the invention is not limited to NR. It may be applied to any generation (3G, 4G, 5G, etc.) of 3GPP networks. However, the invention is not limited to 3GPP networks. It may be applied to other radio networks or even fixed networks which are to be enabled to operate in a band with duty-cycle limitation.

The bands with duty-cycle limitations are not limited to a specific frequency range. As long as the individual duty cycle requirements are met, any frequency band may be used (for instance 430 MHz ISM band as well).

A UE is an example of a terminal. However, the terminal (UE) may be any device capable to connect to the radio network such as a MTC device, a D2X device etc.

A cell may be represented by the base station (e.g. gNB, eNB, etc.) serving the cell. The base station (cell) may be connected to an antenna (array) serving the cell by a Remote Radio Head. A base station may be realized as a combination of a central unit (one or plural base stations) and a distributed unit (one per base station). The central unit may be employed in the cloud.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

According to the above description, it should thus be apparent that example embodiments of the present invention provide, for example, a terminal (such as a UE), or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a network node (such as a base station (e.g. gNB or eNB), a bridge, or a router), or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof.

It is to be understood that what is described above is what is presently considered the preferred example embodiments of the present invention. However, it should be noted that the description of the preferred example embodiments is given by way of example only and that various modifications may be made without departing from the scope of the invention as defined by the appended claims.

1-46. (canceled)

47. A Method, comprising
obtaining at least one of a first duty cycle level and a first reception ratio of a terminal using a first band for transmission;
deciding whether or not the first band is allowed to be allocated to the terminal based on a predetermined first duty cycle restriction of the first band and the at least one of the first duty cycle level and the first reception ratio;
inhibiting allocating the first band to the terminal if the first band is not allowed to be allocated to the terminal; wherein
the first duty cycle level is a ratio of a time duration used by the terminal for transmitting data on the first band during a predetermined time period preceding a time instance of the obtaining and the predetermined time period; and
the first reception ratio is a ratio of a sum of the time durations when the transmission from the terminal in the first band is received during a predetermined time period preceding a time instance of the obtaining and the predetermined time period.

48. The method according to claim 47, further comprising:
obtaining the first reception ratio;
registering each time duration when the transmission from the terminal in the first band is received;
calculating the first reception ratio of the terminal in the first band based on the registered time durations and the predetermined time period.

49. The method according to claim 47, further comprising
reporting the at least one of the first duty cycle level and the first reception ratio to a second base station in a handover procedure of the terminal from a first base station to the second base station.

50. The method according to claim 47, wherein
the at least one of the first duty cycle level and the first reception ratio is obtained based on a report received from a third base station in a handover procedure of the terminal from the third base station to the first base station.

51. The method according to claim 47, wherein
the first duty cycle level is obtained based on a usage report received from the terminal;
the usage report is indicative of the first duty cycle level.

52. The method according to claim 47, wherein
it is decided that the first band is not allowed to be allocated to the terminal if the at least one of the first duty cycle level and the first reception ratio exceeds a predetermined first portion of the predetermined first duty cycle restriction.

53. The method according to claim 47, further comprising
allocating the first band to the terminal if the first band is allowed to be allocated to the terminal.

54. The method according to claim 53, further comprising
setting one of the first band and a second band different from the first band as an active band; wherein
the first band is set as the active band if the first band is allowed to be allocated to the terminal; and
the second band is set as the active band if the first band is not allowed to be allocated to the terminal; and the method further comprises
allocating the active band to the terminal.

55. The method according to claim 54, wherein
the deciding is based on the first duty cycle level; and the method further comprises
informing the terminal on a time duration after which the first duty cycle level will not exceed the first predetermined portion by a predetermined amount when it is monitored that the first duty cycle level exceeds the first predetermined portion;
setting the first band as the active band after the time duration.

56. The method according to claim 54, further comprising
obtaining at least one of a second duty cycle level and a second reception ratio of the terminal;
deciding whether or not the second band is allowed to be allocated to the terminal based on a predetermined second duty cycle restriction of the second band and the at least one of the second duty cycle level and the second reception ratio;
the second duty cycle level is a ratio of a time duration used for transmitting the data on the second band during a second predetermined time period preceding a time instance of the obtaining and the second predetermined time period;
the second reception ratio is a ratio of a sum of the time durations when the transmission from the terminal in the second band is received during a predetermined time period preceding a time instance of the obtaining and the predetermined time period, and the method further comprises
prohibiting the setting of the second band as the active band if the second band is not allowed to be allocated to the terminal.

57. The method according to claim 54, further comprising
notifying the terminal that the active band is changed when the active band is changed.

58. The method according to claim 57, wherein
the terminal is notified by an intra-cell handover procedure of the terminal.

59. The method according to claim 54, further comprising
inhibiting allocating a passive band of the first band and the second band to the terminal, wherein the passive band is different from the active band.

60. Method, comprising
obtaining at least one of a duty cycle level and a reception ratio;
reporting on the at least one of the duty cycle level and the reception ratio; wherein
the duty cycle level is a ratio of a time duration used for transmitting data to a receiver on a first band during a predetermined time period preceding a time instance of the obtaining and the predetermined time period; and
the reception ratio is a ratio of a sum of the time durations when the transmission in the first band is received by the receiver during a predetermined time period preceding a time instance of the obtaining and the predetermined time period.

61. The method according to claim 60, wherein
the reporting comprises reporting at least one of the following occasions:
when it is monitored that the at least one of the duty cycle level and the reception ratio exceeds a first predetermined portion of a predetermined duty cycle restriction;
at periodical time instances;
after handover from a first base station to a second base station is performed, wherein the reporting is to the second base station, and the first base station comprises the receiver.

62. The method according to claim 60, further comprising
checking if the duty cycle level exceeds a second predetermined portion of a predetermined duty cycle restriction; wherein
the receiver is notified by a random access procedure on a second band different from the first band if the duty cycle level exceeds the first predetermined portion, and
a base station comprises the receiver.

63. The method according to claim 60, further comprising
estimating at least one of an expected time duration and an expected duty cycle level;
indicating the at least one of the expected time duration and the expected duty cycle level to the receiver; wherein
the expected duty cycle level is a ratio of the expected time duration expected to be required for transmitting the data on the first band during a predetermined time period after the time instance of the estimating and the predetermined time period.

64. The method according to claim 60, further comprising:
registering each time duration when the transmission in the band is received by the receiver;
calculating the reception ratio based on the registered time durations and the predetermined time period.

65. The method according to claim 60, wherein
the at least one of the duty cycle level and the reception ratio is obtained based on a report received from a third base station in a handover procedure of the terminal from the third base station to the first base station, and the third base station comprises the receiver.

66. An apparatus comprising at least one processor and at least one memory including computer program code, and the at least one processor, with the at least one memory and the computer program code, being arranged to cause the apparatus at least:
to obtain at least one of a first duty cycle level and a first reception ratio of a terminal using a first band for transmission;
to decide whether or not the first band is allowed to be allocated to the terminal based on a predetermined first duty cycle restriction of the first band and the at least one of the first duty cycle level and the first reception ratio;
to inhibit allocating the first band to the terminal if the first band is not allowed to be allocated to the terminal; wherein
the first duty cycle level is a ratio of a time duration used by the terminal for transmitting data on the first band during a predetermined time period preceding a time instance of the obtaining and the predetermined time period; and
the first reception ratio is a ratio of a sum of the time durations when the transmission from the terminal in the first band is received during a predetermined time period preceding a time instance of the obtaining and the predetermined time period.

67. An apparatus comprising at least one processor and at least one memory including computer program code, and the at least one processor, with the at least one memory and the computer program code, being arranged to cause the apparatus at least:
to obtain at least one of a duty cycle level and a reception ratio;
to report on the at least one of the duty cycle level and the reception ratio;
wherein the duty cycle level is a ratio of a time duration used for transmitting data to a receiver on a first band during a predetermined time period preceding a time instance of the obtaining and the predetermined time period; and
wherein the reception ratio is a ratio of a sum of the time durations when the transmission in the first band is received by the receiver during a predetermined time period preceding a time instance of the obtaining and the predetermined time period.
